(19) United States
(12) Patent Application Publication
(10) Pub. No.: US 2010/0031974 A1
(43) Pub. Date: Feb. 11, 2010

(54) Composition and Method

(75) Inventor: Zefferino Righetto, Ladenburg (IT)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt Benckiser N.V., Hoofddorp (NL)

(21) Appl. No.: 12/525,619

(22) PCT Filed: Feb. 7, 2008
(86) PCT No.: PCT/GB2008/000418

§ 371 Date: Oct. 16, 2009

(30) Foreign Application Priority Data
Feb. 7, 2007 (GB) 0702291.6

(51) Int. Cl. C11D 3/22; B08B 7/00

(52) U.S. Cl. 134/7; 510/278

(57) ABSTRACT

A granulated composition suitable for use in a carpet cleaning operation comprising a derivatised/modified cellulose such as a hydrophobic cellulose component and/or a silicified cellulose.

The present invention relates to a granular composition suitable for cleaning carpets and a process of cleaning carpets using a granular composition.

Carpets produced from synthetic or natural fibers and mixtures thereof are commonly used in residential and commercial applications as a floor covering. Various types of fibers can be used in making carpets such as polyamide fibers, polyester fibers as well as wool, cotton or even silk in the case of rugs.

Irrespective of whether the carpets are made from natural or synthetic fibers they are all prone to soiling and staining when contacted with many household items. Foods, grease, oils, beverages in particular such as coffee, tea and soft drinks especially those containing acidic dyes can cause unsightly, often dark stains on carpets. Also fibres may become soiled as a result of dirt particles, clay, dust, i.e. particulate soils in general, coming into contact with and adhering to the fibers of the carpet. These latter soils often appear in the form of a diffuse layer of soils rather than in the form of spots and tend to accumulate particularly in the so called “high traffic areas” such as near doors as a result of intensive use of the carpets in such areas.

Compositions for the cleaning of carpets are already known in the art. For example liquid carpet cleaning compositions based on surfactants other adjunct materials are disclosed in US-A-2005/250662.

The use of these compositions is not without their disadvantages. Firstly, whether the compositions are applied manually or with the use of an application machine, the compositions due to their liquid nature require a long time to be removed from the carpet after the cleaning operation is complete. The removal time can be reduced by the use of a vacuum cleaner but there is still a substantial remaining residue of around 40%.

The residual carpet cleaning liquor is associated with issues such as carpet distortion (shrinkage/expansion), carpet discoloration, odour emanation and can even attract new dirt deposits.

One way to address these shortcomings has been to use a steam operated cleaning device. Such steam driven devices do not suffer to the same extent from the problem of residual water but not only is this problem only partially addressed but moreover the steam driven devices have the added disadvantage in that the machines are cumbersome and awkward to use.

An object of the present invention is to obviate/mitigate the problems outlined above.

According to a first aspect of the invention there is provided a granulated composition suitable for use in a carpet cleaning operation comprising a derivatised/modified cellulose such as a hydrophobic cellulose component and/or a silicified cellulose.

An advantage of composition of the present invention is that the composition is applicable to all carpet types, especially delicate natural fibers, and are also safe to all carpet dye types particularly sensitive natural dyes used therein. The composition of the present invention is also suitable to be used to clean upholstery and car seats covering.

Yet another advantage of the compositions of the present invention is that they may be applied directly on the carpet without causing damage to the carpet.

A further surprising advantage is the finding that the formulation of the present invention can be used in a carpet cleaning operation with a conventional vacuum cleaner without causing any detrimental interaction with the vacuum cleaner. This problem is particularly prevalent in vacuum cleaners which have a paper bag to catch/retain the matter which is picked up by the vacuum cleaner. Some other carpet cleaning powders have been known to block the pores of these paper bags and render the vacuum cleaner inoperative.

Preferred forms of cellulose include cellulose derivatives which have been treated with silica (silicified cellulose). (Silicified cellulose is made by treating cellulose with silica). A preferred form of silicified cellulose is supplied under the Trade Name ProSolv SMCC available from JRS Pharma GMBH+CO KG, Germany

Preferred forms of hydrophobic cellulose include those rendered hydrophobic by treating cellulose with alkylketendimer).

It is appreciated that cellulose has a complex shape: when in particulate form it is not necessarily spherical and is more usually in the form of fibres having a length and a diameter.

Generally the length of the cellulose is up to 1000 μm, more preferably up to 500 μm, more preferably up to 400 μm, and most preferably up to 300 μm.

Generally the diameter of the cellulose is up to 100 μm, more preferably up to 50 μm, more preferably up to 40 μm, more preferably up to 30 μm, more preferably up to 20 μm, and most preferably up to 10 μm.

The cellulose component may comprise up to 100% of the carpet cleaning composition. More preferably the cellulose component comprises less than 75%, more preferably less than 60%, and most preferably less than 50% of the composition. Preferably the cellulose component comprises more than 10%, more preferably more than 20%, and most preferably more than 30% of the composition. Ideally the cellulose component t makes up around 40% of the composition. The composition may contain a relatively small amount of optional/additional components (see below).

A preferred adjunct material incorporated into the carpet cleaning composition is a metal salt, e.g. an alkali metal sulphate salt such as a sodium or potassium salt, e.g. sodium and/or potassium chloride, sulphate, carbonate), bicarbonate) or sesquicarbonate.

Generally the particle size of the metal salt is up to 500 μm, more preferably up to 250 μm. Generally the particle size of the metal salt is above 10 μm.

Where present the metal salt comprises an approximately equal portion of the carpet cleaning composition as the cellulose component. For example both components may comprise up to 50% of the carpet cleaning composition. The composition may contain a relatively small amount of optional/additional components (see below).

The present invention encompasses a process of cleaning a carpet comprising the use of a granulated composition comprising a cellulose component.

Preferably said process of cleaning a carpet further comprises the steps of:
1) applying the granulated cellulose containing composition to the carpet;
2) allowing the cellulose containing composition to interact with a stain/dirt on the carpet; and
3) at least partially removing the cellulose containing composition.

An advantage of the process of cleaning carpets according to the present invention is that of being easy and fast while providing excellent overall cleaning performance. More advantageously, the process of cleaning carpets according to the present invention provides excellent cleaning performance, when both used to clean the whole carpet or localized carpet stains. In addition to this, this process does not leave tacky residue on carpets. Nor is the carpet “wet” after use.

Advantageously, excellent cleaning performance is obtained on different types of stains and soils, especially in the so called “high traffic areas”.

The composition may be applied to the carpet in any convenient manner. The composition may be applied (e.g. manually) via a dispenser such as a rigid/flexible container having a suitable dispensing aperture. Such a dispenser may be operated by shaking over the area of carpet to be cleaned. Alternatively the composition may be applied via a mechanical device. In this case preferably the mechanical dispensing device is attached to/associated with the composition removal device (e.g. a vacuum cleaner (see later)).

The amount of the compositions for the cleaning of carpets according to the present invention applied will depend on the severity of the stain or soil. Generally the composition is applied at an amount of up to 100 g per square metre, more preferably up to 50 g per square metre, more preferably up to 40 g per square metre, more preferably up to 30 g per square metre, more preferably up to 20 g per square metre, and most preferably up to 10 g per square metre.

In the case of stubborn stains more than one application may be required to ensure complete removal of the stain.

The area to be cleaned by applying the compositions according to the present invention may be of any size. Indeed a complete section or more preferably the whole carpet may be treated with the composition for the cleaning of carpets according to the present invention.

In a process of cleaning a carpet according to the present invention the step of applying a composition onto the carpets as described herein before, does not need to be followed by a step where manual action is required other than the final optional removing step. Indeed the compositions herein allow excellent cleaning performance without requiring any manual action like rubbing and/or brushing. An advantage of the present invention is that the cleaning action of the present compositions commences as soon as said compositions are applied onto said carpet.

Typically, the composition is left on the carpet for less than 2 hours, preferably less than 1 hour, more preferably less than 40 minutes, even more preferably from 1 to 30 minutes and most preferably from 1 to 20 minutes (e.g. below 5 minutes).

Preferably said composition is then removed from the carpet. More preferably said composition is removed mechanically, even more preferably by vacuum cleaning. This may be carried out with any commercially available vacuum cleaner.

The detergent composition generally comprises other detergent actives.

Where present it is preferred that the detergent active is granular. Here it is to be understood that the detergent active per se may be granular or the detergent active may be made to be granular by adsorption into/onto another component of the composition (e.g. the cellulose component). Indeed in this regard it is preferred, for liquid detergent actives, that the liquid detergent active is applied to a solid component of the detergent composition (e.g. the cellulose) by a conventional addition mechanism (e.g. by spraying) in order to change the physical form of the liquid active.

Most preferably the granular detergent active has a particle size similar to that of the cellulose.

Surfactants may be present in the composition in an amount of, for example, 0.001 to 30% wt, ideally 0.01 to 15% wt and preferably 0.1 to 5% wt. The surfactant is, for example, an anionic or nonionic surfactant or mixture thereof. The nonionic surfactant is preferably a surfactant having a formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from about 1 to about 12. Examples of other non-ionic surfactants include higher aliphatic primary alcohol containing about twelve to about 16 carbon atoms which are condensed with about three to thirteen moles of ethylene oxide.

Other examples of nonionic surfactants include primary alcohol ethoxylates (available under the Neodol tradename from Shell Co.), such as C₁₁ alkanol condensed with 9 moles of ethylene oxide (Neodol 1-9), C₁₂₋₁₃ alkanol condensed with 6.5 moles ethylene oxide (Neodol 23-6.5), C₁₂₋₁₃ alkanol with 9 moles of ethylene oxide (Neodol 23-9), C₁₂₋₁₅ alkanol condensed with 7 or 3 moles ethylene oxide (Neodol 25-7 or Neodol 25-3), C₁₄₋₁₃ alkanol condensed with 13 moles ethylene oxide (Neodol 45-13), C₉₋₁₁ linear ethoxylated alcohol, averaging 2.5 moles of ethylene oxide per mole of alcohol (Neodol 91-2.5), and the like.

Other examples of suitable nonionic surfactants include ethylene oxide condensate products of secondary aliphatic alcohols containing 11 to 18 carbon atoms in a straight or branched chain configuration condensed with 5 to 30 moles of ethylene oxide. Examples of commercially available non-ionic detergents of the foregoing type are C₁₁₋₁₅ secondary alkanol condensed with either 9 moles of ethylene oxide (Tergitol 15-S-9) or 12 moles of ethylene oxide (Tergitol 15-S-12) marketed by Union Carbide.

Octylphenoxy polyethoxyethanol type nonionic surfactants, for example, Triton X-100, as well as amine oxides can be used as a nonionic surfactant in the present invention.

Other examples of linear primary alcohol ethoxylates are available under the Tomadol tradename such as, Tomadol 1-7, a C₁₁ linear primary alcohol ethoxylate with 7 moles EO; Tomadol 25-7, a C₁₂₋₁₅ linear primary alcohol ethoxylate with 7 moles EO; Tomadol 45-7, a C₁₄₋₁₅ linear primary alcohol ethoxylate with 7 moles EO; and Tomadol 91-6, a C₉₋₁₁ linear alcohol ethoxylate with 6 moles EO.

Other nonionic surfactants are amine oxides, alkyl amide oxide surfactants.

Preferred anionic surfactants are frequently provided as alkali metal salts, ammonium salts, amine salts, aminoalcohol salts or magnesium salts. Contemplated as useful are sulfate or sulfonate compounds including: alkyl benzene sulfates, alkyl sulfates, alkyl ether sulfates, alkylamidoether sulfates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates. Generally, the alkyl or acyl radical in these various compounds comprise a C₁₂₋₂₀ carbon chain.

Other surfactants which may be used are alkyl naphthalene sulfonates and oleoyl sarcosinates and mixtures thereof.

Examples of suitable bleaches are oxygen bleaches. Suitable level of oxygen bleaches is in the range from 0.01 to 90% wt. As used herein active oxygen concentration refers to the percentage concentration of elemental oxygen, with an oxidation number zero, that being reduced to water would be stoichiometrically equivalent to a given percentage concentration of a given peroxide compound, when the peroxide functionality of the peroxide compound is completely reduced to oxides. The active oxygen sources increase the ability of the compositions to remove oxidisable stains, to destroy malodorous molecules and to kill germs.

The concentration of available oxygen can be determined by methods known in the art, such as the iodimetric method, the permanganometric method and the cerimetric method. Said methods and the criteria for the choice of the appropriate method are described for example in “Hydrogen Peroxide”, W. C. Schumo, C. N. Satterfield and R. L. Wentworth, Reinhold Publishing Corporation, New York, 1955 and “Organic Peroxides”, Daniel Swern, Editor Wiley Int. Science, 1970.

Suitable organic and inorganic peroxides for use in the compositions according to the present invention include diacyl and dialkyl peroxides such as dibenzoyl peroxide, dilauroyl peroxide, dicumyl peroxide, persulphuric acid and mixtures thereof.

Suitable preformed peroxyacids for use in the compositions according to the present invention include diperoxydodecandioic acid DPDA, magnesium perphthalatic acid, perlauric acid, perbenzoic acid, diperoxyazelaic acid and mixtures thereof. Peroxygen bleaching actives useful for this invention are: percarbonates, perborates, peroxides, peroxyhydrates, persulfates. A preferred compound is sodium percarbonate and especially the coated grades that have better stability. The percarbonate can be coated with silicates, borates, waxes, sodium sulfate, sodium carbonate and surfactants solid at room temperature.

Optionally, the composition may comprise from 0.1% to 30%, preferably from 2% to 20% of peracid precursors, i.e. compounds that upon reaction with hydrogen peroxide product peroxyacids. Examples of peracid precursors suitable for use in the present invention can be found among the classes of anhydrides, amides, imides and esters such as acetyl triethyl citrate (ATC) described for instance in EP 91 87 0207, tetra acetyl ethylene diamine (TAED), succinic or maleic anhydrides.

The composition may comprise a builder or a combination of builders, for example in an amount of from 0.01 to 50% wt, preferably from 0.1 to 20% wt.

Examples of builders are described below
the parent acids of the monomeric or oligomeric polycarboxylate chelating agents or mixtures therefore with their salts, e.g. citric acid or citrate/citric acid mixtures are also contemplated as useful builder components.
borate builders, as well as builders containing borate-forming materials than can produce borate under detergent storage or wash conditions can also be used.
iminosuccinic acid metal salts
polyaspartic acid metal salts.
ethylene diamino tetra acetic acid and salt forms.
water-soluble phosphonate and phosphate builders are useful for this invention. Examples of phosphate builders are the alkali metal tripolyphosphates, sodium potassium and ammonium pyrophosphate, sodium and potassium and ammonium pyrophosphate, sodium and potassium orthophosphate sodium polymeta/phosphate in which the degree of polymerisation ranges from 6 to 21, and salts of phytic acid. Specific examples of water-soluble phosphate builders are the alkali metal tripolyphosphates, sodium potassium and ammonium pyrophosphate, sodium and potassium and ammonium pyrophosphate, sodium and potassium or thophosphate, sodium polymeta/phosphate in which the degree of polymerization ranges from 6 to 21, and salts of phytic acid. Such polymers include the polycarboxylates containing two carboxy groups include the water-soluble salts of succinic acid, malonic acid, (ethylenedioxy) diacetic acid, maleic acid, diglycolic acid, tartaric acid, tartronic acid and fumaric acid, as well as the ether carboxylates and the sulfinyl carboxylates.

Polycarboxylates containing three carboxy groups include, in particular, water-soluble citrates, aconitrates and citraconates as well as succinate derivates such as the carboxymethloxysuccinates described in GB-A-1,379,241, lactoxysuccinates described in GB-A-1,389,732, and aminosuccinates described in NL-A-7205873, and the oxypolycarboxylate materials such as 2-oxa-1,1,3-propane tricarboxylates described in GB-A-1,387,447.

Polycarboxylate containing four carboxy groups include oxydisuccinates disclosed in GB-A-1,261,829, 1,1,2,2-ethane tetracarboxylates, 1,1,3,3-propane tetracarboxylates and 1,1,2,3-propane tetracarobyxlates. Polycarboxylates containing sulfo substituents include the sulfosuccinate derivatives disclosed in GB-A-1,398,421, GB-A-1,398,422 and U.S. Pat. No. 3,936,448, and the sulfonated pyrolsed citrates described in GB-A-1,439,000.

Alicylic and heterocyclic polycarboxylates include cyclopentane-cis,cis,cis-tetracarboxylates, cyclopentadienide pentacarboxylates, 2,3,4,5,6-hexane-hexacarboxylates and carboxymethyl derivates of polyhydric alcohols such as sorbitol, mannitol and xylitol. Aromatic polycarboxylates include mellitic acid, pyromellitic acid and the phthalic acid derivatives disclosed in GB-A-1,425,343.

Of the above, the preferred polycarboxylates are hydroxycarboxylates containing up to three carboxy groups per molecule, more particularly citrates.

Suitable polymers include the water soluble monomeric polycarboxylates, or their acid forms, homo or copolymeric polycarboxylic acids or their salts in which the polycarboxylic acid comprises at least two carboxylic radicals separated from each other by not more than two carbon atoms, carbonates, bicarbonates, borates, phosphates, and mixtures of any of thereof.

The carboxylate or polycarboxylate builder can be monomeric or oligomeric in type although monomeric polycarboxylates are generally preferred for reasons of cost and performance.

Suitable carboxylates containing one carboxy group include the water soluble salts of lactic acid, glycolic acid and ether derivatives thereof. Polycarboxylates containing two carboxy groups include the water-soluble salts of succinic acid, malonic acid, (ethylenedioxy) diacetic acid, maleic acid, diglycolic acid, tartaric acid, tartronic acid and fumaric acid, as well as the ether carboxylates and the sulfinyl carboxylates. Polycarboxylates containing three carboxy groups include, in particular, water-soluble citrates, aconitrates and citraconates as well as succinate derivates such as the carboxymethloxysuccinates described in GB-A-1,379,241, lactoxysuccinates described in GB-A-1,389,732, and aminosuccinates described in NL-A-7205873, and the oxypolycarboxylate materials such as 2-oxa-1,1,3-propane tricarboxylates described in GB-A-1,387,447.

Polycarboxylate containing four carboxy groups include oxydisuccinates disclosed in GB-A-1,261,829, 1,1,2,2-ethane tetracarboxylates, 1,1,3,3-propane tetracarboxylates and 1,1,2,3-propane tetracarobyxlates. Polycarboxylates containing sulfo substituents include the sulfosuccinate derivatives disclosed in GB-A-1,398,421, GB-A-1,398,422 and U.S. Pat. No. 3,936,448, and the sulfonated pyrolsed citrates described in GB-A-1,439,000.

Alicylic and heterocyclic polycarboxylates include cyclopentane-cis,cis,cis-tetracarboxylates, cyclopentadienide pentacarboxylates, 2,3,4,5,6-hexane-hexacarboxylates and carboxymethyl derivates of polyhydric alcohols such as sorbitol, mannitol and xylitol. Aromatic polycarboxylates include mellitic acid, pyromellitic acid and the phthalic acid derivatives disclosed in GB-A-1,425,343.

Of the above, the preferred polycarboxylates are hydroxycarboxylates containing up to three carboxy groups per molecule, more particularly citrates.

More preferred polymers are homopolymers, copolymers and multiple polymers of acrylic, fluorinated acrylic, sulfonated styrene, maleic anhydride, metacrylic, isobutylene, styrene and ester monomers.

Examples of these polymers are Acusol supplied from Rohm & Haas, Syntran supplied from Interpolymer and Versa and Alcosperse series supplied from Alco Chemical, a National Starch & Chemical Company.

The parent acids of the monomeric or oligomeric polycarboxylate chelating agents or mixtures therefore with their salts, e.g. citric acid or citrate/citric acid mixtures are also contemplated as useful builder components.

In the context of the present application it will be appreciated that builders are compounds that sequester metal ions associated with the hardness of water, e.g. calcium and magnesium, whereas chelating agents are compounds that sequester transition metal ions capable of catalysing the degradation of oxygen bleach systems. However, certain compounds may have the ability to do perform both functions.

Suitable chelating agents to be used herein include chelating agents selected from the group of phosphonate chelating agents, amino carboxylate chelating agents, polyfunctionally-substituted aromatic chelating agents, and further chelating agents like glycine, salicylic acid, aspartic acid, glutamic acid, malonic acid, or mixtures thereof. Chelating agents when used, are typically present herein in amounts ranging from 0.01% to 50% wt of the total composition and preferably from 0.05% to 10% wt.

Suitable phosphonate chelating agents to be used herein may include ethydronic acid as well as amino phosphonate compounds, including amino alkylene poly (alkylene phosphonate), alkali metal ethane 1-hydroxy diphosphonates, nitrilo trimethylene phosphonates, ethylene diamine tetra methylene phosphonates, and diethylene triamine penta methylene phosphonates. The phosphonate compounds may be present either in their acid form or as salts of different cations on some or all of their acid functionalities. Preferred phosphonate chelating agents to be used herein are diethylene triamine penta methylene phosphonates. Such phosphonate chelating agents are commercially available from Monsanto under the trade name DEQUEST™.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids is, for instance, commercially available under the tradename ssEDDS™ from Palmer Research Laboratories.

Suitable amino carboxylates include ethylene diamine tetra acetates, diethylene triamine pentaacetates, diethylene triamine pentaacetate (DTPA), N-hydroxyethylethylenediamine triacetates, nitrilotriacetates, ethylenediamine tetrapropionates, triethylenetetraaminehexa-acetates, ethanol-diglycines, propylene diamine tetracetic acid (PDTA) and methyl glycine diacetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid which is commercially available from BASF under the trade name Trilon FS™.

Solvents can be used for present invention at levels of 0.01 to 30% wt, preferred level is between 0.1-3% wt. The solvent constituent may include one or more alcohol, glycol, acetate, ether acetate, glycerol, polyethylene glycol with molecular weight ranging from 200 to 1000, silicones or glycol ethers. Exemplary alcohols useful in the compositions of the invention include C₂₋₈ primary and secondary alcohols which may be straight chained or branched, preferably pentanol and hexanol.

Preferred solvents for the invention are glycol ethers and examples include those glycol ethers having the general structure. Preferred solvents for the invention are glycol ethers and examples include those glycol ethers having the general structure Ra-O—[CH₂—CH(R)—(CH₂)—O]ₙ—H, wherein Ra is C₁₋₂₀ alkyl or alkenyl, or a cyclic alkane group of at least 6 carbon atoms, which may be fully or partially unsaturated or aromatic; n is an integer from 1 to 10, preferably from 1 to 5; each R is selected from H or CH₃; and a is the integer 0 or 1. Specific and preferred solvents are selected from propylene glycol methyl ether, dipropylene glycol methyl ether, tripropylene glycol methyl ether, propylene glycol n-propyl ether, ethylene glycol n-butyl ether, diethylene glycol n-butyl ether, diethylene glycol methyl ether, propylene glycol, ethylene glycol, isopropanol, ethanol, methanol, diethylene glycol monoethyl ether acetate, and particularly useful are, propylene glycol phenyl ether, ethylene glycol hexyl ether and diethylene glycol hexyl ether.

The composition may comprise an enzyme. Example of suitable enzymes are proteases, modified proteases stable in oxidisable conditions, amylases and lipases.

Additionally, optional ingredients may be included. Suitable optional ingredients comprise optical brighteners, fragrances, dyes.

The invention will now be described with reference to the following non-limiting Examples.

### EXAMPLES

### Liquid Formula 1

A liquid formulation was made up as follows.

| Liquid formula 1 | |
|---|---|
| Alcohol Ethoxylate 7EO | 2.00 |
| IDS Tetrasodium salt, 34% | 1.70 |
| Hydrogen Peroxide, 50% | 4.00 |
| Dowanol PM | 2.50 |
| Dowanol DPnP | 7.50 |
| Antifoam BF-20 Plus Dow Corning | 0.15 |
| Citric Acid | 0.15 |
| Deionised Water Europe | 82.00 |
| total | 100.00 |

A granular formulation was made up as follows.

| | A | B | C | D | E | F | G | H |
|---|---|---|---|---|---|---|---|---|
| Liquid formula 1 | 10.0 | 10.0 | 20.0 | 20.0 | 20.0 | 20.0 | 15.0 | 15.0 |
| Arbocel Plus BWW 40-60 AKD | 40.0 | | 40.0 | | | | 35.0 | 45.0 |
| Arbocel Plus BWW 60-120 AKD | | 40.0 | | 40.0 | | | | |
| Prosolv SMCC 50 | | | | | 40.0 | | | |
| Prosolv SMCC 90 | | | | | | 40.0 | | |
| Sodium sulphate (40-250 μm) | 50.0 | 50.0 | 40.0 | 40.0 | 40.0 | 40.0 | 50.0 | 40.0 |
| Total | 100.0 | 100.0 | 100.0 | 100.0 | 100.0 | 100.0 | 100.0 | 100.0 |

The formulation was used as follows.

| | A | B | C | D | E | F | G | H |
|---|---|---|---|---|---|---|---|---|
| Dosage (gr/m2) | 20 | 20 | 20 | 20 | 20 | 20 | 20 | 20 |
| Soil Removal % | 15.2 | 15.2 | 14.7 | 14.5 | 13.3 | 13.6 | 16.2 | 15.7 |
| Bulk Density (gr/l) | 420 | 405 | 347 | 347 | 402 | 518 | NA | 350 |
| Bag clogging at (gr) | NA | NA | NA | NA | NA | NA | NA | 1000 |

### Liquid Formula 2

A liquid formulation was made up as follows.

| Liquid formula 2 | |
|---|---|
| Na Lauryl Sulfate, 29% | 3.45 |
| Alkylbenzene Sulphonic Acid | 0.45 |
| Emulan HE-50 | 0.25 |
| Dowanol DPnP | 0.90 |
| Dowanol DPnB | 1.45 |
| NaOH, 50% | 0.12 |
| Fragrance | 0.15 |
| Hydrogen Peroxide, 50% | 4.83 |
| Acrylic Copolymer - Syntran 4022 | 1.80 |
| IDS Tetrasodium salt, 34% | 1.80 |
| Citric Acid Anhydrous | 0.25 |
| Deionised Water | 84.55 |
| total | 100.00 |

A granular formulation was made up as follows.

| | A | B | C | D | E | F | G | H |
|---|---|---|---|---|---|---|---|---|
| Liquid formula 2 | 18.0 | 18.0 | 18.0 | 18.0 | 18.0 | 17.5 | 17.5 | 18.0 |
| Arbocel Plus BWW 40-60 AKD | 7.5 | | | | | | | |
| Arbocel B800 60 AKD | | 7.5 | | 9.0 | | 10.0 | | |
| Arbocel B600 60 AKD | | | 7.5 | | 9.0 | | 10.0 | 7.5 |
| Sipernat 22 | 3.5 | 3.5 | 3.5 | 3.0 | 3.0 | 2.5 | 2.5 | 3.5 |
| Sodium sulphate (40-250 μm) | 71.0 | 71.0 | 71.0 | 70.0 | 70.0 | 70.0 | 70.0 | 71.0 |
| Total | 100.0 | 100.0 | 100.0 | 100.0 | 100.0 | 100.0 | 100.0 | 100.0 |

The formulation was used as follows.

| | A | B | C | D | E | F | G | H ** |
|---|---|---|---|---|---|---|---|---|
| Dosage | 10 | 10 | 10 | 10 | 10 | 10 | 10 | 10 |
| (gr/m2) | | | | | | | | |
| Soil Removal | 17.5 | 16.4 | 18.8 | 14.5 | 17.6 | 16.1 | 17.5 | 18.5 |
| % | | | | | | | | |
| Bag clogging | 420 | 425 | 420 | 280 | 270 | 230 | 225 | 420 |
| at (gr) | | | | | | | | |

### Liquid Formula 3

A liquid formulation was made up as follows.

| Liquid formula 3 | |
|---|---|
| Na Lauryl Sulfate, 29% | 3.45 |
| Alkylbenzene Sulphonic Acid | 0.45 |
| Emulan HE-50 | 0.25 |
| Dowanol DPnP | 0.90 |
| Dowanol DPnB | 1.45 |
| NaOH, 50% | 0.12 |
| Fragrance | 0.15 |
| Acrylic Copolymer - Syntran 4022 | 1.80 |
| IDS Tetrasodium salt, 34% | 1.80 |
| Deionised Water | 89.63 |
| total | 100.00 |

A granular formulation was made up as follows.

| | A | B |
|---|---|---|
| Liquid formula 3 | 18.0 | 18.0 |
| Arbocel B600 60 AKD | 7.5 | 7.5 |
| Sipernat 22 | 3.5 | 3.5 |
| Sodium sulphate (40-250 microns) | 71.0 | 71.0 |
| Total | 100.0 | 100.0 |

The formulation was used as follows.

| | A | B ** |
|---|---|---|
| Dosage (gr/m2) | 10 | 10 |
| Soil Removal % | 17.4 | 24.0 |
| Bag clogging at (gr) | 380 | 380 |

** soil level ΔE 3.5. All other soil levels ΔE 6.5

1. A granulated carpet cleaning composition comprising a derivatised and/or modified cellulose and/or a silicified cellulose.

2. A composition according to claim 1, wherein the length of the cellulose is up to 1000 μm.

3. A composition according to claim 1, wherein the diameter of the cellulose is up to 100 μm.

4. A composition according to claim 1, wherein the composition further comprises a metal salt.

5. A composition according to claim 4, wherein the particle size of the metal salt is up to 500 μm.

6. A composition according to claim 4, wherein the metal salt comprises an approximately equal portion of the carpet cleaning composition as the cellulose component.

7. A composition according to claim 1, wherein the composition further comprises a detergent active.

8. A process of cleaning a carpet comprising the step of: applying a granulated composition comprising a hydrophobic cellulose component and/or a silicified cellulose to a carpet.

9. A process according to claim 8, wherein the process comprises the steps of:
1) applying the granulated cellulose containing composition to the carpet;
2) allowing the cellulose containing composition to interact with a stain and/or dirt on the carpet; and
3) at least partially removing the cellulose containing composition from the carpet.

10. A process according to claim 9, wherein in step 3) the removal of the cellulose containing composition is carried out using a vacuum cleaner.

11. A process according to claim 9, wherein the cellulose composition is applied at an amount of about 10 g/m².

12. A process according to claim 9, wherein the time allowed for step 2) is up to two hours.

13. A composition according to claim 2, wherein the length of the cellulose is up to 500 μm.

14. A composition according to claim 13, wherein the length of the cellulose is up to 400 μm.

15. A composition according to claim 14, wherein the length of the cellulose is up to 300 μm.

16. A composition according to claim 1 wherein the diameter of the cellulose is up to 50 μm.

17. A composition according to claim 16 wherein the diameter of the cellulose is up to 40 μm.

18. A composition according to claim 17 wherein the diameter of the cellulose is up to 30 μm.

19. A composition according to claim 18 wherein the diameter of the cellulose is up to 20 μm, and most preferably up to 10 μm.

20. A composition according to claim 19 wherein the diameter of the cellulose is up to 10 μm.
